(19) United States
(12) Patent Application Publication
(10) Pub. No.: US 2009/0194312 A1
(43) Pub. Date: Aug. 6, 2009

(54) CONVERTIBLE COVER PLATE FOR A FLOOR BOX

(75) Inventors: Robert K. Jolly, Cordova, TN (US); Joey D. Magno, JR., Cordova, TN (US)

Correspondence Address: HOFFMANN & BARON, LLP, 6900 JERICHO TURNPIKE, SYOSSET, NY, 11791, US

(73) Assignee: Thomas & Betts International, Inc., Wilmington, DE (US)

(21) Appl. No.: 12/023,109

(22) Filed: Jan. 31, 2008

(51) Int. Cl. H02G 3/14

(52) U.S. Cl. 174/67

(57) ABSTRACT

Disclosed herein is an electrical floor box cover assembly with a convertible top plate. The inventive convertible top plate can be installed in two orientations, resulting in either a flush or recessed finished assembly. The cover assembly is affixed to a floor mounted electrical box, and includes a floor box cover having a center opening, with the inventive convertible cover plate affixed thereto. In a first orientation of the cover plate, a cover plate protrusion is inserted into the center opening of the floor box cover, providing a flush surface in the cover assembly. In a second orientation, a flat surface of the cover plate is facing up, so that the center opening of the floor box cover forms a recess in the cover assembly. Also provided is a port in the floor box cover, through which cables or wires can be threaded from the electrical fixture to the exterior of the floor box cover assembly while the cover is in an attached position.

### FIELD OF INVENTION

This invention relates to electrical boxes mounted on a floor, and provides a convertible, reversible cover, permitting the top plate to be either recessed or flush with the floor surface, with a single set of parts.

### BACKGROUND OF THE INVENTION

Electrical boxes fitted into a floor, flush or recessed with the floor surface, are an important architectural feature, permitting electrical connections to be supplied to an area in a room distal from a wall. Suitable electrical connections that are commonly supplied through floor boxes include electric power, telephone, network, cable TV connections, and so forth.

Electrical floor boxes typically provide a plastic or metal box that is installed into the flooring material or structure, that provides a housing for an electrical fixture, such as a plug outlet for 120/240 volt power. The top of the box must be covered by a top plate, to prevent debris from entering the fixture, which could possibly damage the fixture or cause a short circuit. Aesthetically, a top plate or cover on the box is also important to provide a quality appearance and attractive finish. In alternative embodiments, an electrical fixture may be mounted directly on a plate that is fitted into or onto a suitably sized hole cut in the floor, without an enclosed box embedded below the floor surface.

The top portion of an electrical floor box typically includes a floor box flange around the perimeter that conceals the rough opening and fits into or onto the box, if present. Additionally, the top portion includes a floor box cover that is permanently or removably affixed to the floor box flange. For example, the floor box cover may be hinged or affixed with tabs to the flange, so as to be easily removable or adjustable between an open and closed position. When the cover is flipped up or otherwise opened, the electrical fixture is exposed for use. When the cover is closed, the electrical fixture is concealed and protected, so as to be architecturally attractive, and not a tripping hazard. Thus, for example, people can walk over it safely and furniture can be placed on top safely.

As a matter of aesthetic and architectural preference, top plates for electrical floor boxes can be considered as comprising two styles, flush and recessed. In a flush top plate, the entire surface of the top plate is flush with the floor box flange. This permits the top plate, which is exposed to view, to be of a uniform color, material, and finish. In a recessed style top plate, the center portion of the top plate is recessed relative to the flange to permit an insert of flooring material into the top plate, such as carpet, wood, or tile, to provide a more uniform appearance in the finished installation, relative to the surrounding floor material.

In order to accommodate flush and recess style floor box covers, a floor box may supplied to an installer with either a flush or recessed floor plate in the package, or it may be supplied with both types of floor plates. An electrical floor box supplied with only one type of plate requires the installer to order the correct style of part in advance. In the case where both types of floor plates are supplied, costs are higher because of the second plate enclosed, and because one of the floor plates is discarded, which is wasteful.

### SUMMARY OF THE INVENTION

This invention provides an electrical floor box cover assembly, with a convertible top plate. The inventive convertible top plate can be installed in two possible orientations, resulting in either a flush or recessed finished assembly. Thus, this invention provides a convertible cover plate for a floor mounted electrical box, with a first flat surface and a protrusion on the opposite surface, where the protrusion is sized to fit into an outer cover, and where the convertible cover plate can be installed with the flat surface or the surface bearing the protrusion facing up.

Further, this invention provides a cover assembly for a floor mounted electrical box, with a floor box cover having a center opening, where the floor box cover is affixed to the floor mounted electrical box, and a convertible cover plate with a first flat surface and a second surface having a protrusion, where said cover plate can be affixed to the floor box cover with the protrusion inserted into the center opening of the floor box cover, providing a flush surface in the assembled cover assembly, or where the flat surface of the cover plate is facing up when affixed to the floor box cover, so that the center opening of the floor box cover forms a recess in the assembled cover assembly.

Additionally, the cover assembly may also include a floor box flange, which is permanently affixed to the floor or a floor mounted electrical box, wherein the floor box cover is detachably affixed to the floor box flange, and the cover can be detached.

In an embodiment of this invention, there is provided a cable access port in the floor box cover, through which cables or wires can be threaded from the electrical fixture to the exterior of the floor box cover assembly while the cover is in a closed or attached position.

Still further, the cover assembly may include a gasket interposed between the convertible top plate and the cover, which provides waterproofness, and protects the interior of the fixture from liquids and dust.

### BRIEF DESCRIPTION OF THE DRAWINGS

FIG. 1 shows the top of the convertible cover plate flush to the top surface of the floor box cover and flange, with the cable access port open.

FIG. 2 shows an exploded view of the flange and cover plate assembly in the flush mount orientation.

FIG. 3 shows the top of the convertible cover plate recessed to accept finish floor covering such as carpet, wood, tile, etc. The cable access port is open.

FIG. 4 shows an exploded view of the flange and cover plate assembly in the recess mount orientation.

FIG. 5 shows the convertible cover plate in the closed position with the top plate oriented so that the cable access port is not open.

### DETAILED DESCRIPTION OF THE INVENTION

This invention provides a floor box cover assembly with a convertible top plate, such that the assembly can be fitted at the work site with either a flush or recess mounted top plate. In the inventive top plate, there is provided a convertible cover plate, made with one surface flat, and the other surface containing a protrusion that fits closely inside an opening of a floor box cover. When the protrusion is fit into the cover in this manner, the entire top surface of the assembled top plate presents a uniform flush surface, with the top of the floor box cover and flange being perfectly aligned.

The inventive convertible top plate can be installed in either a flush or recessed orientation. Installing the top plate with the flat surface up will result in a recessed cover in the assembled top plate. Conversely, installing the top plate with the protruding surface up will result in a flush cover.

The floor box cover assembly includes a top cover subassembly removably affixed to a floor box flange. The flange is affixed to a floor surface. Within the flange is a cavity which is intended to contain an electrical fixture, such as 120/240 volt electric power, telephone, network, cable TV connections, and so forth. In one position, the top cover is closed or firmly attached to the flange, concealing and protecting the electrical fixture in the cavity. In a second position, the top cover is opened or detached from the flange, to expose the electrical fixture for use. Additionally, in some embodiments of this invention, there may be a cable access port in the top cover, to provide an exit for cables or wires while the top cover is closed. With the cable access port, for example, an electrical appliance can be plugged into the fixture in the cavity while the top cover is closed.

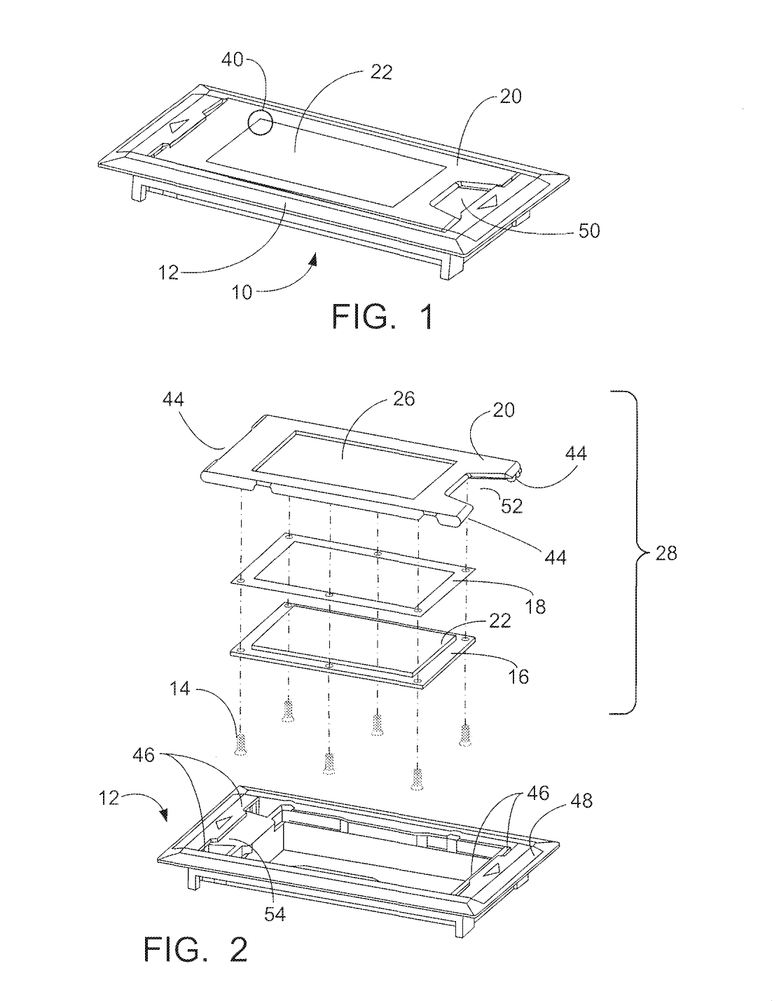

An embodiment of the invention is illustrated in the attached figures. FIG. 1 shows the complete floor box assembly 10, with the top of the convertible cover plate flush to the top surface of the floor box cover and flange. FIG. 2 is an exploded view of the parts of this invention in the flush mount configuration. In this embodiment, the floor box cover 20 is fastened to the convertible cover plate 16 with screws 14, to form box cover subassembly 28. A gasket 18 is interposed between the convertible top plate and the floor box cover. This gasket provides waterproofness, so that the installed cover meets UL scrub water requirements.

A floor box flange 12 perimetrically covers a floor box (not shown), or alternatively, an opening cut in the floor without an enclosed floor box to contain an electrical fixture. The flange 12 conceals the rough opening regardless of whether an enclosed floor box is employed. The interior space of the flange 12 is occupied by an electrical fixture (not shown), such as, for example, an electrical power outlet or a female RJ45 Ethernet jack. The fixture may be mounted within an enclosed floor box, or the fixture may be mounted on hardware affixed to the flange 12 (not shown), with or without a separate enclosed floor box. While the flange in the figures is depicted as rectangular in shape, other shaped flanges are within the scope of this invention. For example, the flange may be circular. The top of flange 12 is raised above the surface of the floor when installed, since the bottom of the lip of the flange must rest on the floor surface.

The floor box flange 12 will be permanently affixed to the floor in some manner, such as with screws (not shown). In embodiments where there is an enclosed electrical floor box below the surface of the floor, the flange will typically be affixed to the electrical box with screws. In an embodiment without an electrical box, the flange may be affixed to an underlayer with screws, or the flange may affixed to the floor with spring clips or similar structure (not shown).

The floor box cover 20 forms a frame around a center opening 26, and is removably affixed to the flange 12. The box cover subassembly 28 is flush with the flange box cover 12 when affixed to the flange, as shown in FIGS. 1, 3, and 5. When subassembly 28 is closed, the electrical fixture within the flange is protected and concealed from view.

The floor box cover must be removable, detachable, or openable to expose the electrical fixture inside for use, for example, to plug a cable into a female electrical outlet. In an embodiment shown in the figures, the floor box cover illustrated in the figures has tabbed edges 44 that fit into slots 46 in the flange box cover 12 and permit the box cover-cover plate assembly to be easily detached from the flange 12 to expose an electrical fixture inside (not shown). The box cover subassembly 28 is secured to the flange with a movable locking member 48. Part 48 has two positions. In the locked position, the cover is attached to the flange, and movable part 48 secures the tabs 44 on box cover 20. To remove the cover, member 48 slides outward slightly to an unlocked position to release the tabs on box cover 20, allowing the box cover to be slipped out of the slots, and detached from the flange.

Other embodiments for affixing the floor box cover to the flange are within the scope of this invention. For example, there may be a hinging arrangement, whereby the box cover can be flipped up. In such an embodiment, there would be a hinge along one edge of the box cover, allowing the cover assembly to rotate around the axis of the hinge. In another embodiment, the box cover may be affixed to the flange with screws or some other means requiring a tool to open or release the cover. In another embodiment, there may be a lanyard connecting the floor box cover to the flange, so that when the floor box cover is detached from the flange, it remains connected by the lanyard can cannot be lost or misplaced.

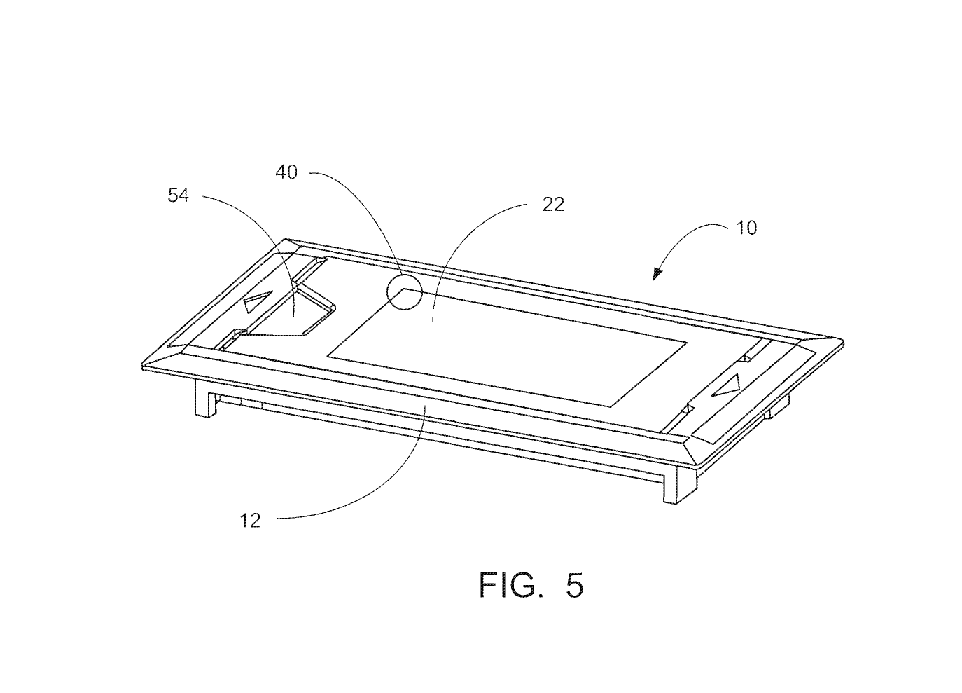

The convertible cover plate 16 in this invention has two distinct opposed planar surfaces. A first surface 24 (see FIG. 4) is substantially flat across the entire surface of cover plate 16. A second planar surface 22 (see FIG. 2), on the opposite side of planar surface 24, has a raised or protruded portion of the surface, relative to the surrounding the perimeter of cover plate 16. The protruded portion of 16 is sized so as to fit within opening 26 in floor box cover 20 in the flush mount configuration. The size of the protruded portion of 16 is of dimensions to completely fill the opening 26, and be at the same height as the top of the floor box cover 20, to provide a flush cover in the complete assembly 10. Thus, when the protruded surface 22 is mounted into subassembly 28 facing up, the subassembly 28 will have a flush surface, as depicted in the complete assembly 10 in FIGS. 1 and 5. As shown at location 40, there are no walls of the interior of box cover 20 visible in the flush mount configuration.

The perimeter of convertible cover plate 16 provides space for mounting screws 14 that affix the cover plate 16 to the floor box cover 20.

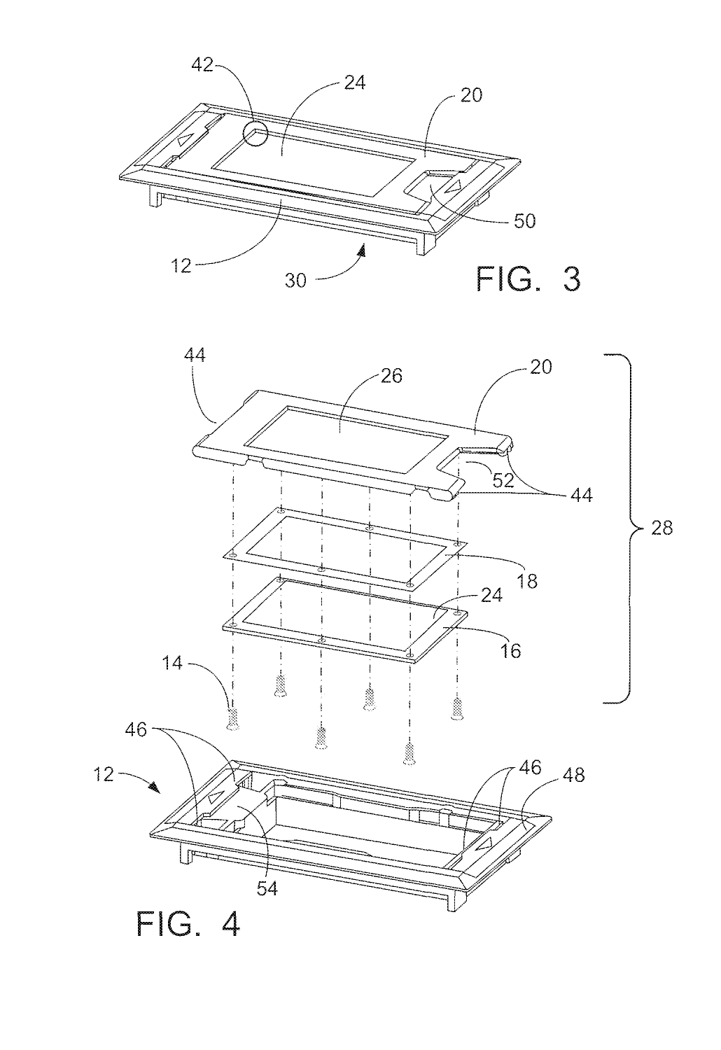

FIGS. 3 and 4 illustrate a recess mount arrangement of this invention. The convertible cover plate 16 is oriented so that the flat side is up. The protrusion 22 is facing downwards, and is concealed in this orientation. Thus, in the subassembly 28 of this orientation, the interior walls forming the opening 26 in the floor box cover 20 form a recess, with the floor of the recess being the surface 24 of convertible cover plate 16, and with walls from opening 26. The recess in the fully assembled and closed configuration is shown in FIG. 3. As shown at location 42, the walls formed by the interior of opening 26 are visible.

The depth of the recess 24 can be varied by selection of the thickness of the floor box cover 20 and floor box flange 12. The cover 20 and flange 12 must have the same thickness, so that the complete assembly 10 or 30 presents a uniform height above the floor, except for the recess in 30. Different floor thicknesses require a recess of different thickness. For example, vinyl flooring is typically ⅛″ thick. Wood flooring can vary, and is commonly ¼″ to ½″ thick. In the case of very thick flooring materials, such as ½″ wood planking, it may be necessary to employ a thin longitudinal slice of the floor material that fits into the recess to provide a fully flush surface in the complete assembly. Conversely, in the case of vinyl flooring, it may be necessary for the installer to build up the thickness of the finished floor insert. For example, if the recess is ¼″ deep, and the flooring is ⅛″ vinyl flooring, the installer would have to use a double layer of the ⅛″ flooring to achieve a flush surface in the finished assembly.

In some embodiments of this invention, a cable access port, 50 in FIGS. 1 and 3, may be provided in the top cover to provide an opening through which cables or wires (not shown) can be threaded while the top cover is closed. With the cable access port, for example, an electrical appliance can be plugged into the electrical fixture within the flange 12 while the top cover is closed. In the embodiment illustrated in the figures, the cable access port is an opening in the top cover 20 formed by the indent 52 on one edge of cover 20. In this embodiment, the cover assembly 28 can be affixed with either the indent 52 on the right side or the left side, as drawn in the Figures. In FIGS. 1-4, the cover assembly is oriented with the indent 52 on the right side, which provides the cable access port. Alternatively, the cover assembly 28 can be rotated 180 degrees and affixed to the flange with the indent 52 on the left side (as drawn), shown in FIG. 5. In FIG. 5, the indent 52 is not oriented over the cavity of flange 12, but rather is situated over a ledge 54 that provides a seal with no access to the cavity within flange 12. Note in the foregoing discussion that the flange 12 has a fixed orientation in all the figures, but the cover assembly 28 can be installed in one of two positions, with indent 52 to the right or to the left (as drawn in the figures), to provide for a port or not with the same parts.

In the embodiment of this invention illustrated in the figures, the parts in a package delivered to the consumer would contain a floor box flange 12, a floor box cover 20, a gasket 18, screws 14, and the convertible cover plate 16. During installation and assembly, all parts would be used, and the convertible cover plate 16 would be installed in either a flush or recess orientation. The convertible cover plate 16, gasket 18, and floor box cover 20 would be screwed together, to provide the cover subassembly 28 with the desired flushed or recess style, depending on the orientation of convertible cover plate 16. The flange would be affixed to the floor. The tabs on the floor box cover 20 would be inserted into the floor box flange, to provide the complete assembly. No unused parts would be in the package.

A further advantage is that the same package can be delivered to either recess or flush mount installations, with the convenience of not needing to order, in advance, one of two possible orientations. A further advantage to this invention is a reduction in finished parts that need to be manufactured, and in a reduction in the number of complete packages that need to be stocked at suppliers. The reduction in SKU's is an advantage. Thus, the inventive product is expected to have lower costs compared to the prior art.

1. A floor box cover assembly comprising:
(a) a floor box flange mounted on a floor, where the flange perimeter forms a cavity within which is an electrical fixture;
(b) a floor box cover frame removably affixed to said flange for movement between a first attached position, and a second detached position, with said frame defining a bounded opening; and
(c) a reversible cover plate mounted to said cover frame within said bounded opening in one of two alternate orientations; said cover plate having a first planar surface which is flush with said cover frame in a first orientation and an opposed second planar surface which forms a recess bounded by said frame in the second orientation.

2. The cover assembly of claim 1, wherein the floor box flange is affixed to an enclosed electrical box affixed below the surface of the floor.

3. A floor box cover assembly of claim 1, wherein the cover frame is removably attached to the flange with one or more tabbed outer edges on the cover frame that interlock with slots on the flange, and whereby a releasing means is provided to detach the cover frame from the flange.

4. A floor box cover assembly of claim 1, wherein said opposed second planar surface accommodates a floor covering within said recess defined by said second planar surface.

5. A floor box cover assembly of claim 1, wherein said cover plate includes a perimetrical rim mountable to said cover frame and a first planar surface laving a raised central member extending from said rim, and a second substantially flat planar surface.

6. A floor box cover assembly of claim 5, wherein said raised central member is insertable into said bounded opening of said cover frame in the first orientation.

7. A floor box cover assembly of claim 1, wherein a perimetrical gasket is interposed between said cover frame and said cover plate.

8. A floor box cover assembly of claim 1, wherein a cable access port is provided through which cables or wires can be threaded from the electrical fixture to the exterior of the floor box cover assembly while the cover is in the attached position.

9. A floor box cover assembly of claim 1, wherein the cover frame can be affixed in a first orientation to provide a cable access port through which cables or wires can be threaded from the electrical fixture to the exterior of the floor box cover assembly while the cover is in the attached position, or a second orientation with no port.

10. A floor box cover assembly of claim 1, wherein the cover frame can be affixed in two orientations; where in the first orientation, the cover frame has an opening therethrough as a cable access port, providing a channel from the cavity defined by the perimeter of the floor box flange to the exterior of the floor box cover assembly; and where in the second orientation a protrusion of the flange blocks the opening on the cover frame, thereby providing no channel to the cavity defined by the perimeter of the floor box flange.

11. A convertible cover plate for a floor mounted electrical fixture, comprising a first flat surface and a protrusion on the opposite surface, where the protrusion is sized to fit into an outer cover, and where the convertible cover plate can be installed with the flat surface or the surface bearing the protrusion facing up.
